(19) United States
(12) Patent Application Publication
(10) Pub. No.: US 2013/0059987 A1
(43) Pub. Date: Mar. 7, 2013

(54) Functionalized Silicon Carbide And Functionalized Inorganic Whiskers For Improving Abrasion Resistance Of Polymers

(71) Applicants: Thomas E. Quantrille, Greenville, SC (US); Lewis A. Short, Piedmont, SC (US)

(72) Inventors: Thomas E. Quantrille, Greenville, SC (US); Lewis A. Short, Piedmont, SC (US)

(73) Assignee: ADVANCED COMPOSITE MATERIALS, LLC, Greer, SC (US)

(21) Appl. No.: 13/225,661

(22) Filed: Sep. 6, 2011

(51) Int. Cl. C08G 71/04; C07F 7/02; C07F 7/10

(52) U.S. Cl. 525/453; 556/413; 428/367; 549/215

(57) ABSTRACT

Inorganic particulate or whiskers are surface-treated to facilitate receptivity to covalent bonding with a coupling agent. Surface treatment forms reactive groups that enable the inorganic particulate or whiskers to covalently bond to a reactive group of the coupling agent. The coupling agent also contains organofunctional groups, which in some examples may be covalently bonded to a polymer matrix by way of crosslinking or by co-polymerizing the functionalized particulate or whiskers together with polymer precursors. The resulting polymeric materials exhibit markedly improved abrasion resistance as well as other improved properties.

### BACKGROUND

Polymeric materials, especially coatings, generally need high levels of abrasion resistance. Functionalized silica and other types of inorganic materials have been added to make polymeric materials stiffer and improve abrasion resistance somewhat. In some instances, whiskers have been used in primers of non-stick coating systems to improve the adhesion of subsequent topcoats. See U.S. Pat. No. 5,560,978 to Leech, which describes a two-coat system with a basecoat that includes a high temperature binder resin and a nickel filamentary powder to form a sponge-like material with a roughened surface and an internal structure containing interlocking channels. The roughened surface enables a fluoropolymer topcoat to be anchored therein, thus improving adhesion of the topcoat to the basecoat.

Whisker materials also have been used in topcoats of non-stick finishes to improve wear resistance. JP 3471562 B2, for example, discloses using potassium hexatitanate whiskers in a fluoropolymer topcoat of one-coat and two-coat systems to improve wear- and scratch resistance of the non-stick surface. The coatings further include spherical ceramic pigments, glass beads containing SiO₂ and Al₂O₃, to improve abrasion resistance.

Cardoso et al. U.S. 2009/0202782 A1 describes a scratch resistant non-stick finish which includes a primer layer, a midcoat layer, and a topcoat layer. The primer layer is adhered to a substrate and includes a first polymer binder and large ceramic particles. The midcoat layer includes a first fluoropolymer composition and inorganic whiskers, and the topcoat layer includes a second fluoropolymer composition.

While these efforts have accomplished some improvement in abrasion resistance, there remains a need for further improvements in abrasion resistance of polymeric materials, especially in polymeric coating materials. All of the above references can only deliver limited improvements because of a lack of affinity between the filler and the polymer matrix.

### SUMMARY

In some aspects, silicon carbide (particulate or whiskers) is surface-treated to render it receptive to covalent bonding with a coupling agent. In some embodiments, surface treatment is conducted by way of thermal oxidation. In other embodiments, surface treatment is conducted by way of chemical oxidation. The oxidative treatment forms reactive hydroxyl groups on the surface, which enables the treated surface to bond to a coupling agent via a condensation reaction that releases water. The coupling agent also contains one or more free organofunctional groups, such that the union of the surface-treated silicon carbide and coupling agent forms functionalized silicon carbide.

This functionalized silicon carbide can be chosen specifically to be compatible with and have high affinity for the polymer matrix to which it will be added. In some embodiments, the organofunctional groups are covalently bonded to a polymer matrix, e.g., by reacting the functionalized silicon carbide with polymeric materials to cause crosslinking, or by co-polymerizing the functionalized silicon carbide together with polymer precursors. In other embodiments, the functionalized silicon carbide may have high physical affinity to the polymer matrix, where the organofunctional group is compatible or miscible with the polymer matrix resulting in physical adhesion to the polymer matrix.

In another aspect, inorganic whiskers are surface-treated to render them receptive to a covalently bonded coupling agent. The surface treatment may be conducted by way of thermal oxidation or chemical oxidation. This surface oxidation results in hydroxyl groups on the surface. The coupling agent has a reactive group that will react with the hydroxyl group on the surface in a condensation reaction that releases water. In addition, the coupling agent possesses at least one organofunctional group. The organofunctional group may be bonded to a polymer matrix, e.g., by reacting the functionalized inorganic material with polymer materials to cause crosslinking, or by co-polymerizing the functionalized inorganic material with polymer precursors. Alternatively, the functionalized inorganic whiskers may have high physical affinity to the polymer matrix, where the organofunctional group is compatible or miscible with the polymer matrix resulting in physical adhesion to the polymer matrix.

Polymeric materials containing the functionalized inorganic particles or whiskers as disclosed herein may exhibit abrasion resistance that is exceptional and heretofore unachieved in polymeric materials. The materials also may exhibit other improved properties, such as increased electrical conductivity, Young's modulus, flex modulus, and specific heat, as described below.

### BRIEF DESCRIPTION OF THE DRAWINGS

FIG. 1 is a graph illustrating comparing the life of fluoropolymer coatings having additives of carbon black, SiC particles, and functionalized SiC.

FIG. 2 is a graph illustrating abrasion resistance for phenolic resins containing no additives and additives of SiC whiskers and functionalized SiC whiskers.

FIG. 3 is a graph illustrating abrasion resistance for unsaturated polyester resins containing no additives and additives of SiC whiskers and functionalized SiC whiskers.

FIG. 4 is a graph illustrating abrasion resistance for polyurethane resins containing no additives and additives of SiC whiskers and functionalized SiC whiskers.

### DETAILED DESCRIPTION OF THE INVENTION

The inventors found that functionalized silicon carbide particulate or whiskers, and other types of functionalized inorganic whiskers, may be incorporated into polymeric systems to dramatically improve abrasion resistance as well as other properties such as electrical conductivity, flex modulus, specific heat, and Young's modulus.

Unless otherwise clear from context, percentages disclosed herein are expressed as percent by weight based on the total weight of the composition.

Silicon Carbide

Silicon carbide exists in about 250 crystalline forms. The polymorphism of SiC is characterized by a large family of similar crystalline structures called polytypes, which are variations of a chemical compound that are identical in two dimensions and differ in the third. Alpha silicon carbide (α-SiC) is the most commonly encountered polymorph; it is formed at temperatures greater than 1700° C. and has a hexagonal crystal structure. The beta modification (β-SiC), with a cubic crystalline structure (similar to diamond), is formed at temperatures below 1700° C. The beta form has been used as a support for heterogeneous catalysts, owing to its higher surface area compared to the alpha form.

The high sublimation temperature of SiC (approximately 2700° C.) makes it useful for bearings and furnace parts. Silicon carbide does not melt at any known temperature. It is also highly inert chemically. There is currently much interest in its use as a semiconductor material in electronics, where its high thermal conductivity, high electric field breakdown strength and high maximum current density make it more promising than silicon for high-powered devices. SiC also has a very low coefficient of thermal expansion (4.0×10⁻⁶/K) and experiences no phase transitions that would cause discontinuities in thermal expansion. Silicon carbide is a semiconductor, which can be doped n-type by nitrogen or phosphorus and p-type by aluminum, boron, gallium, or beryllium. Metallic conductivity has been achieved by heavy doping with elements such as boron, aluminum, or nitrogen.

Silicon carbide particles may vary in particle size over a wide range depending on such factors as the crystal structure and the intended use. It is often desirable to use materials having a substantially uniform particle size (or relatively narrow particle size distribution). By way of example and without limiting the invention, maximum particle size may range from about 0.05 μm (nano-sized) to about 100 μm or more. In practice, maximum particle size often ranges from about 1 μm to about 75 μm, from about 5 μm to about 50 μm, or from about 10 μm to about 40 μm.

Inorganic Whiskers

Inorganic whiskers, sometimes referred to as nanotubes, can be characterized by their elastic modulus as measured in gigapascals (GPa). Examples of inorganic whiskers with a high elastic modulus include inorganic oxides, carbides, borides and nitrides, metals such as stainless steel, zirconium, tantalum, titanium, tungsten, boron, aluminum, and beryllium. Examples of some typical elastic modulus values include: silicon nitride (310 GPa); stainless steel (180-200 GPa); alumina (428 GPa); boron carbide (483 GPa); silicon carbide (480 GPa). The inorganic whiskers may be particles of a single ceramic or metal, or a mixture of whiskers of different ceramics or metals.

Inorganic whiskers typically have a diameter of from about 0.2 to about 10 μm, often from about 0.3 to about 3 μm, more often from about 0.4 to about 2 μm, and usually from about 0.5 to about 1.5 μm. The aspect ratio, i.e., the ratio of length to diameter (L/D), of whiskers generally is greater than about 3:1 and typically ranges from about 10:1 to about 100:1, often from about 10:1 to 50:1 or from about 12:1 to about 20:1. One such commercially available single crystal silicon carbide whisker product is available from Advanced Composite Materials, LLC of Greer, S.C., under the trade name Silar® brand silicon carbide whiskers. This product comprises single crystal silicon carbide whiskers having an average diameter of 0.6 μm and an average length of 9 μm. Silicon carbide whiskers may be made in accordance with the method disclosed in Cutler, U.S. Pat. No. 3,754,076, the disclosure of which is hereby incorporated by reference.

Surface Treatment

Inorganic materials such as silicon carbide and those described above with respect to inorganic whiskers, tend to be chemically inert. The inorganic particulate or whiskers typically must be initially surface-treated to render the material chemically receptive to a coupling agent. In the case of silicon carbide, for example, surface treatment may involve oxidation to form approximately 1 to 15 wt. % silica. Various forms of hydrated silica can appear on the surface. In addition, oxidation of SiC forms SiOH, which is chemically reactive to coupling agents. Surface treatment may be carried out, for example, by thermal oxidation or chemical oxidation, as described more fully below.

A. Thermal Oxidation

In some embodiments, surface treatment of the inorganic particulate or whiskers is achieved by way of thermal oxidation. Silicon carbide, for example, is thermally stable at temperatures up to about 600° C. When heated to temperatures above 600° C., silicon carbide oxidizes to form silica and SiOH, with CO₂ formed as a by-product. In one technique, silicon carbide particulate or whiskers are heated with light agitation to a temperature above 600° C. in the presence of air or other oxygen-containing environment. An ozone atmosphere is also viable. Other types of inorganic whiskers also may be surface-treated using a similar technique, recognizing the particular temperature at which oxidation occurs may vary for different materials. This technique may be generally similar to the process of calcination used in the mineral industry.

B. Chemical Oxidation

Silicon carbide particulate or whiskers, or other type of inorganic whiskers, alternatively may be surface-treated by way of chemical oxidation. For example, fluoro-oxidation may be conducted at room temperature by contacting the inorganic particulate or whiskers with fluorine gas, a highly reactive oxidizing agent. Suitable equipment for carrying out such chemical oxidation is commercially available, such as the equipment used by Fluoro-Seal, Ltd. for surface oxidation of plastics. See, e.g., Bauman et al. U.S. Pat. No. 6,441,128, the disclosure of which is hereby incorporated by reference in its entirety. In general, chemical oxidation affords a simpler but more expensive process as compared to thermal oxidation.

Another type of chemical oxidation is gas plasma oxidation. In this process a gas plasma is generated (via thermal or electrical means). Gas plasma contains large amounts of oxide-containing free radicals. The gas plasma is placed in contact with the surface of the inorganic whiskers. The gas plasma then oxidizes the surface of the inorganic whiskers, rendering the surface reactive with —OH groups. As with other forms of oxidation, gas plasma release CO₂. The —OH groups formed on the surface can then react with coupling agents in a condensation reaction that releases water.

Coupling Agents

A coupling agent should be capable of covalently bonding to the surface-treated inorganic particulate or whiskers. In the case of silicon carbide, for example, the coupling agent should have a reactive group that is capable of reacting with the SiOH, SiO₂, or other —OH moieties present on the treated surface. The chemical structure of the coupling agent may vary depending on such considerations as the properties of the inorganic particulate or whiskers used, as well as the type and properties of polymeric material that will ultimately be used. Non-limiting examples of coupling agents include organosilanes, such as those commercially available from such suppliers as Silar Laboratories, Dow Chemical, and Nanjing Union Silicon Chemical Co., Ltd. Other types of coupling agents include titanium-based compounds, and compounds of aluminum, zirconium, tin, and nickel.

Organosilane coupling agents are silicon-based compounds that contain two types of functional groups (e.g., organic and inorganic) in the same molecule. A general structure of a typical silane coupling agent is:

(RO)₃SiCH₂CH₂CH₂—X,

where RO can be a reactive group, such as methoxy, ethoxy, or acetoxy, and X is an organofunctional group, such as amino, methacryloxy, epoxy, etc. The reactive (RO) group is capable of covalently bonding to the active moieties on the treated surface of the inorganic material. The structure above illustrates a coupling agent that has three (RO) groups that are reactive to the inorganic surface. Coupling agents may be mono-, di-, or tri-reactive to the inorganic surface. Note that depending on the chemistry and mechanism, the RO group can be first hydrolyzed and then reacted with the surface. Alternatively, a direct transesterification reaction can occur with no hydrolysis.

For chemically bonding into the polymer matrix, the organofunctional (X) group of the coupling agent is capable of covalently bonding to a polymeric material, via free radical, condensation, or step polymerization reactions. Non-limiting examples of organofunctional groups that may be present include alkane, alkene, alcohol, epoxy, methoxy, ethoxy, acetoxy, vinyl, vinyl halide, azide, mono-amine, di-amine, tri-amine, carboxyl, and combinations thereof. The organofunctional group may contain, by way of example, from 1 to 12 carbon atoms. For improved physical adhesion to the polymer matrix, which is more common in non-reactive thermoplastic resins, the organofunctional (X) group may be alkane, alkene, alkyne, alcohol, carbonyl (either as an aldehyde or ketone), amine, amide, ester, aromatic, benzyl, phenolic, etc. Depending on the particular organofunctional group present, the coupling agent may exhibit a range of different properties, e.g., hydrophilic, lipophilic, etc., which may be tailored for a particular polymer system to be used.

The amount of coupling agent used may vary over a wide range depending on such factors as the type and surface area of the inorganic material used. In general, the amount of coupling agent usually ranges from about 0.5 to about 15 wt. %, often from about 1 to about 5 wt. %, based on the total weight of the inorganic particulate or whiskers and coupling agent.

The coupling agent may be covalently bonded to the surface-treated inorganic particulate or whiskers by combining the two components together. One method of applying the coupling agent is to spray-apply the coupling agent onto the powder as it is being tumbled in a mixer. Temperatures of 60° C. to 80° C. are frequently needed to react the coupling agent with the oxidized surface. This type of reaction is a direct transesterification that typically releases an alcohol. Another option is to mix the coupling agent in an aqueous slurry containing the inorganic whisker. The slurry is de-watered and dried by conventional means (heated drying, spray drying, vacuum drying, freeze drying, pan-drying, etc.). Once all of the water is eliminated from the system, a condensation reaction occurs that bonds the coupling agent to the surface.

Polymeric Materials

The functionalized inorganic particulate and whiskers as described herein may be used together with a wide variety of polymers for a variety of different applications. The polymers may be thermoplastic or thermoset. Glassy thermosets can be “activated” when heated above their glass transition temperature, e.g., to change from a hard, glassy polymer into a soft, rubbery elastomer. Hot-melt adhesives and polymers that cure with heat also may be used as a matrix material for functionalized inorganic whiskers or particulate.

Examples of polymers often used in coating systems include fluoropolymers (e.g., polytetrafluoroethylene or PTFE), phenolic resins, saturated or unsaturated polyesters (e.g., polyethylene terephthalate or PET), polyurethanes, polycarbonates, and polyolefins. Other non-limiting examples of polymers that may be used include acrylics, vinyl compounds (e.g., vinyl halides, vinyl acetates, vinyl alcohols, and vinylidene halides), polyetherimides, polyamides, polyphenylene ethers, aliphatic polyketones, polyetherether ketones, polysulfones, aromatic polyesters, novolac resins, silicone resins, epoxy resins, and polyphenylenesulfides. Blends of compatible polymers also may be used.

In some embodiments, the functionalized particulate or whiskers are physically mixed with the polymer to promote physical adhesion. In other embodiments, the functionalized whiskers or particle are combined with one or more polymer precursors, oligomers, or crosslinking agents, and the materials are co-polymerized together to form a polymeric material. In some cases, the polymer precursors may cure by cross-linking with heat. Free radical and step polymerization processes are also viable. The precursors may be inorganic, organic, or a hybrid of the two. Other types of materials that may be used include mixtures of polymer cerams, and sol-gels that form ceramic powders.

In some aspects, the organofunctional group of the functionalized particulate or whiskers covalently bonds to a polymeric matrix, e.g., to create crosslinking. The extent of crosslinking may vary from relatively low levels of crosslinking up to relatively high levels of crosslinking, depending on the desired properties of the resulting polymeric material. In general, crosslinking was found to improve abrasion resistance of many different types of polymer systems.

In the case where the polymer is not cross-linked with the functionalized particulate or whiskers is not does not occur, the organofunctional group may be selected to be compatible with a particular polymeric material in terms of properties such as polarity, such that the functionalized inorganic particulate or whiskers may be easily incorporated into the polymeric material as an additive for improving abrasion resistance and/or other properties. Modifying surface energies to promote wettability physical adhesion will also improve mechanical properties.

The amount of functionalized particulate or whiskers incorporated into the polymer may vary over a wide range depending on the respective materials used and the desired properties of the resulting polymeric material. In general, the amount of functionalized particulate or whiskers incorporated into the polymeric material (or precursors used to form the polymeric material) ranges from about 1 to about 30 wt. %, often from about 3 to about 20 wt. %, and more usually from about 8 to about 15 wt. %, based on the total weight of the composition.

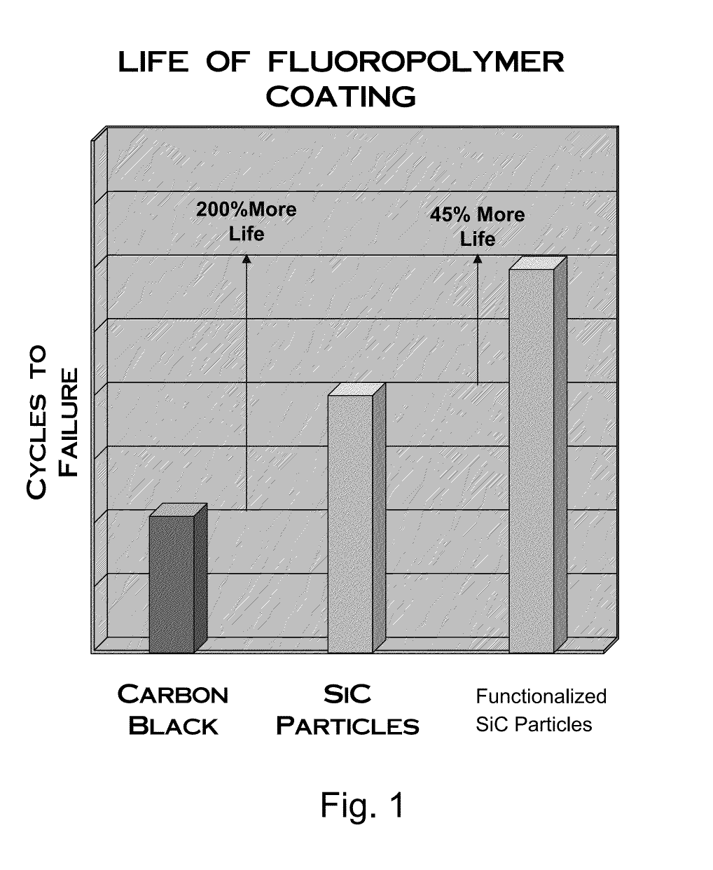

Abrasion resistance may be measured using standard techniques well known to persons skilled in the art, such as ASTM D4060-10. With reference to FIGS. 1-4, the functionalized particulate and whiskers described herein were found to dramatically improve abrasion resistance in a variety of types of polymers. FIG. 1 shows that a fluoropolymer coating that was modified by functionalized SiC particles exhibited 200% more life than a fluoropolymer coating modified by carbon black, and 45% more life than a fluoropolymer coating modified by SiC particles.

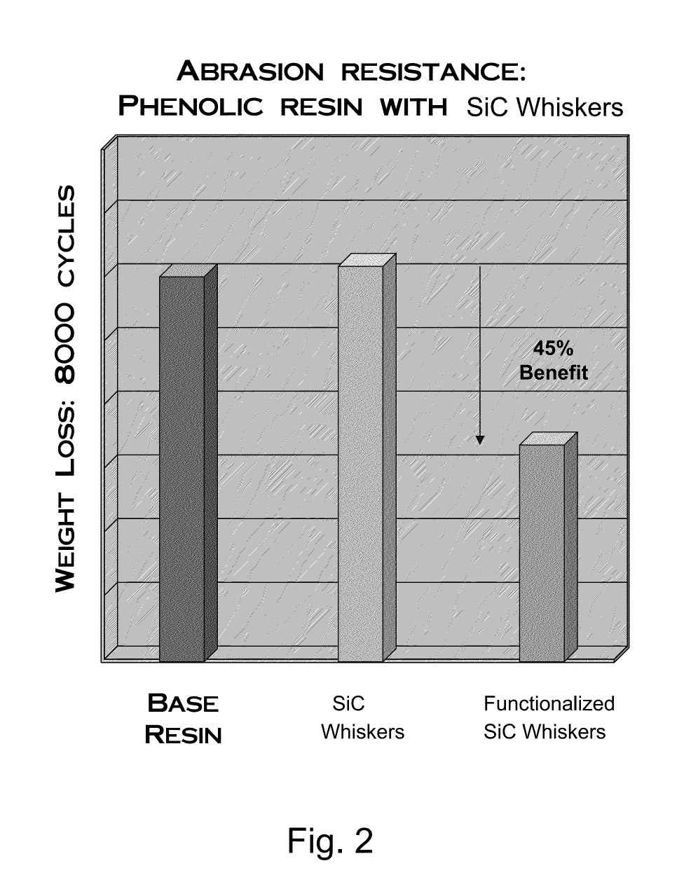

FIG. 2 shows improvements in abrasion resistance for a phenolic resin. The left-hand bar shows weight loss of the unmodified resin after 8000 test cycles. No improvement was seen in a phenolic resin modified with SiC whiskers (center bar). However, the phenolic resin that was modified with functionalized SiC whiskers (right-hand bar) exhibited 45% improvement over the unmodified resin.

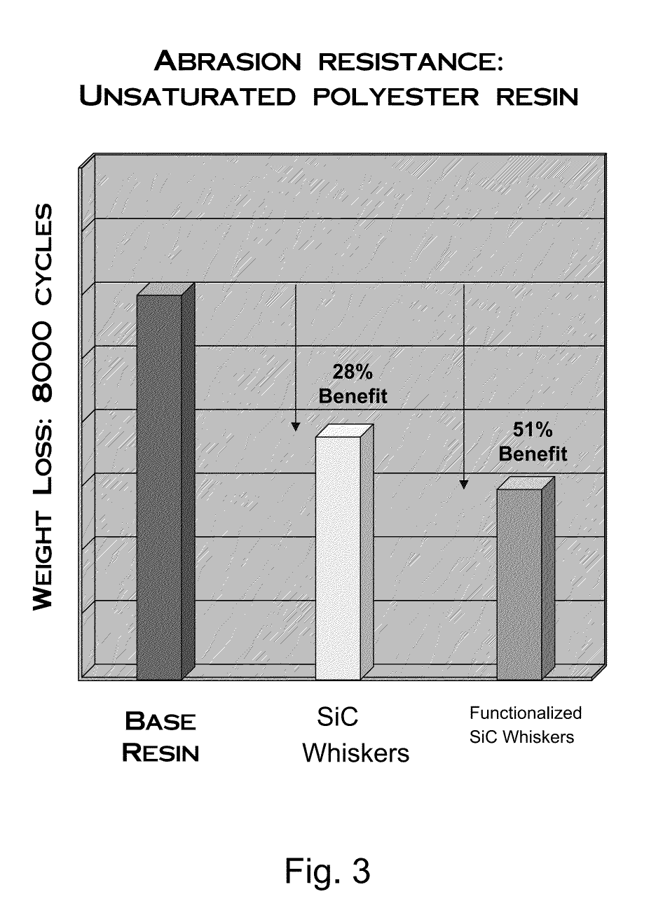

FIG. 3 shows abrasion resistance for unsaturated polyester resins. The bar on the left-hand side shows weight loss after 8000 test cycles for the unmodified resin. The center bar shows the results for a resin that included SiC whiskers (28% improvement over unmodified resin). The right-hand bar shows the resin that was modified with functionalized SiC whiskers exhibited a 51% improvement over the unmodified resin.

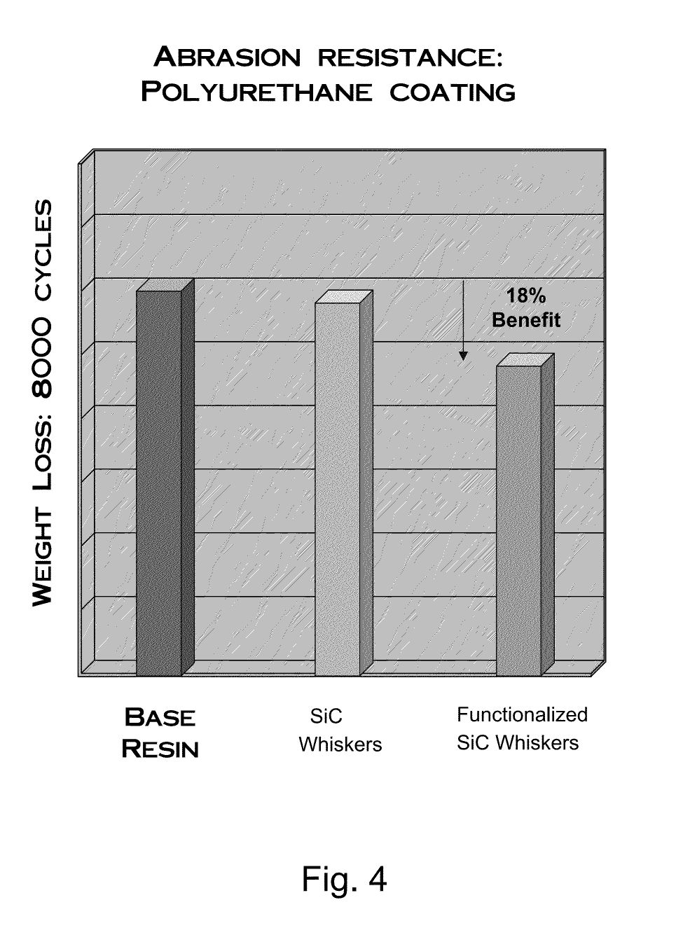

FIG. 4 shows abrasion resistance results for polyurethane resins. A resin modified with functionalized SiC whiskers (right-hand bar) exhibited an 18% improvement over the unmodified resin (left-hand bar), while the resin modified with SiC whiskers did not exhibit a significant improvement over the unmodified resin.

In addition to abrasion resistance, the functionalized inorganic particulate and whiskers also may impart a variety of other properties to the polymeric material, including increased electrical conductivity, increased flex modulus, increased Young's modulus, increased thermal conductivity, and increased specific heat.

### EXAMPLES

The following examples are provided for purposes of illustration, and should not be regarded as limiting the invention.

### Example 1

### Improved Abrasion Resistance of Polyester Resin with Amine Functionalized SiC

Silicon carbide whiskers were treated with fluorine gas followed by oxygen to activate the surface of the SiC. The oxygen purge reacted with fluorine moieties on the surface to create an oxidized surface with the presence of hydroxyl (—OH) groups on the surface.

This hydroxylated surface was then reacted with an organosilane. The organosilane has active Si—OH groups that react with the —OH on the surface in a condensation reaction. Water is released and the result is a siloxane coupling that binds the organosilane molecule to the surface.

The organic functional group in the organosilane includes an amine constituency. This amine constituency is reactive with urethanes and possibly other polymers. The result is a chemical bond between the silicon carbide whisker and the polymer matrix.

A polyester resin with amine-functionalized SiC whiskers was coated onto a wood substrate. The resulting coating was cured. It was then subjected to a Taber abrasion test under the following conditions:
Abrasion Wheel: CS-17
Applied Weight: 1000 g

This example tested the base polyester resin with no added SiC whiskers, with 5% un-treated SiC whiskers and then 5% SiC whiskers treated at 1, 3, and 5% organosilane. The results are shown in Table 1 below.

TABLE 1
Abrasion Resistance of Unsaturated Polyester
Resin with Amine Functionalized SiC.

| Sample | Percent Weight Loss |
|---|---|
| Resin Only | 1.59 |
| Untreated SiC Whisker | 1.48 |
| Oxidized SiC Whisker | 1.34 |
| Amine functionalized, 1% add-on | 1.06 |
| Amine functionalized, 3% add-on | 0.78 |
| Amine functionalized, 5% add-on | 0.89 |

### Example 2

### Improved Abrasion Resistance of Polyester Resin with Epoxy Functionalized SiC

Silicon carbide whiskers were treated with fluorine gas followed by oxygen to activate the surface of the SiC. The oxygen purge reacted with fluorine moieties on the surface to create an oxidized surface with the presence of hydroxyl (—OH) groups on the surface.

This hydroxylated surface was then reacted with an organosilane. The organosilane has active Si—OH groups that react with the —OH on the surface in a condensation reaction. Water is released and the result is a siloxane coupling that binds the organosilane molecule to the surface.

In this example, the organic functional group in the organosilane includes an epoxy constituency. This epoxy constituency is reactive with epoxy based and possibly other polymers. The result is a chemical bond between the silicon carbide whisker and the polymer matrix.

In this example a polyester resin with epoxy-functionalized SiC whiskers was coated onto a wood substrate. The resulting coating was cured. It was then subjected to a Taber abrasion test under the following conditions:
Abrasion Wheel: CS-17
Applied Weight: 1000 g

This example tested the base polyester resin with no added SiC whiskers, with 5% un-treated SiC whiskers and then 5% SiC whiskers treated at 1, 3, and 5% organosilane. The results are shown in Table 2 below.

TABLE 2
Abrasion Resistance of Unsaturated Polyester
Resin with Epoxy-Functionalized SiC.

| Sample | Percent Weight Loss |
|---|---|
| Resin Only | 1.59 |
| Untreated SiC Whisker | 1.48 |
| Oxidized SiC Whisker | 1.34 |
| Epoxy functionalized, 1% add-on | 1.14 |
| Epoxy functionalized, 3% add-on | 1.15 |
| Epoxy functionalized, 5% add-on | 1.15 |

### Example 3

### Improved Abrasion Resistance of Polyurethanes

Silicon carbide whiskers were treated with fluorine gas followed by oxygen to activate the surface of the SiC. The oxygen purge reacted with fluorine moieties on the surface to create an oxidized surface with the presence of hydroxyl (—OH) groups on the surface.

This hydroxylated surface was then reacted with an organosilane. The organosilane has active Si—OH groups that react with the —OH on the surface in a condensation reaction. Water is released and the result is a siloxane coupling that binds the organosilane molecule to the surface.

In this example, the organic functional group in the organosilane includes an amine constituency. This amine constituency is reactive with urethanes and possibly other polymers. The result is a chemical bond between the silicon carbide whisker and the polymer matrix.

In this example, a water based polyurethane resin with amine-functionalized SiC whiskers was coated onto a wood substrate. The resulting coating was cured. It was then subjected to a Taber abrasion test under the following conditions:
Abrasion Wheel: CS-17
Applied Weight: 1000 g

This example tested the base polyester resin with no added SiC whiskers, with 5% un-treated SiC whiskers and then 5% SiC whiskers treated at 1, 3, and 5% organo-silane. The results are shown in Table 3 below.

TABLE 3
Abrasion Resistance of Unsaturated Polyester
Resin with Epoxy-Functionalized SiC.

| Sample | Percent Weight Loss |
|---|---|
| Polyurethane Resin Only | 0.511 |
| Untreated SiC Whisker | 0.505 |
| Oxidized SiC Whisker | 0.508 |
| Amine functionalized, 1% add-on | 0.465 |
| Amine functionalized, 3% add-on | 0.442 |
| Amine functionalized, 5% add-on | 0.397 |

While the invention has been described with respect to specific examples including presently preferred modes of carrying out the invention, those skilled in the art will appreciate that there are numerous variations and permutations of the above described systems and techniques that fall within the spirit and scope of the invention as set forth in the appended claims.

We claim:

1. Functionalized silicon carbide comprising silicon carbide particulate or whiskers covalently bonded to a coupling agent having at least one organofunctional moiety.

2. The functionalized silicon carbide of claim 1 wherein the silicon carbide is in the form of whiskers.

3. The functionalized silicon carbide of claim 2 wherein the whiskers have a diameter from about 0.2 to about 10 μm and an aspect ratio from about 10:1 to about 25:1.

4. The functionalized silicon carbide of claim 1 wherein the silicon carbide is in the form of a particulate.

5. The functionalized silicon carbide of claim 1 wherein the organofunctional moiety is selected from the group consisting of alkane, alkene, alcohol, epoxy, methoxy, ethoxy, acetoxy, vinyl, mono-amine, di-amine, tri-amine, and combinations thereof.

6. A polymer compound comprising the functionalized silicon carbide of claim 1.

7. The polymer compound of claim 6 wherein the functionalized silicon carbide at least partially crosslinks or chemically bonds into or with the polymer.

8. The polymer of claim 6 wherein the polymer is selected from the group consisting of fluoropolymers, phenolic resins, polyesters, polyurethanes, polyolefins, acrylics, polyetherimides, polyamides, polyphenylene ethers, aliphatic polyketones, polyetherether ketones, polysulfones, aromatic polyesters, novolac resins, silicone resins, epoxy resins, polyphenylenesulfides, and combinations thereof.

9. Functionalized inorganic whiskers comprising inorganic whiskers covalently bonded to a coupling agent having at least one organofunctional moiety.

10. The functionalized whiskers of claim 9 wherein the inorganic whiskers are selected from the group consisting of inorganic oxides, carbides, borides, nitrides, stainless steel, zirconium, tantalum, titanium, tungsten, boron, aluminum, beryllium, and combinations thereof.

11. The functionalized whiskers of claim 9 wherein the organofunctional moiety is selected from the group consisting of alkane, alkene, alcohol, epoxy, methoxy, ethoxy, acetoxy, vinyl, mono-amine, di-amine, tri-amine, and combinations thereof.

12. A polymer comprising the functionalized whiskers of claim 9.

13. The polymer of claim 12 wherein the functionalized whiskers at least partially crosslink the polymer.

14. The polymer of claim 12 wherein the polymer is selected from the group consisting of fluoropolymers, phenolic resins, polyesters, polyurethanes, polyolefins, acrylics, polyetherimides, polyamides, polyphenylene ethers, aliphatic polyketones, polyetherether ketones, polysulfones, aromatic polyesters, novolac resins, silicone resins, epoxy resins, polyphenylenesulfides, and combinations thereof.

15. A method of preparing functionalized silicon carbide, comprising:
providing silicon carbide particulate or whiskers;
surface treating the silicon carbide to form a treated surface containing one or more reactive groups;
contacting the treated surface with a coupling agent having a reactive group and an organofunctional group, under conditions sufficient to covalently bond reactive groups on the treated surface of the silicon carbide.

16. The method of claim 15 wherein the silicon carbide is in the form of whiskers.

17. The method of claim 15 wherein the whiskers have a diameter from about 0.2 to about 10 μm and an aspect ratio from about 10:1 to about 25:1.

18. The method of claim 15 wherein the silicon carbide is in the form of a particulate.

19. The method of claim 15 wherein the silicon carbide is surface treated by thermal oxidation.

20. The method of claim 15 wherein the silicon carbide is surface treated by chemical oxidation.

21. The method of claim 15 wherein the coupling agent comprises an organosilane.

22. The method of claim 15 wherein the coupling agent comprises an organometallic compound.

23. The method of claim 21 wherein the reactive group of the coupling agent is selected from the group consisting of methoxy, ethoxy, and acetoxy.

24. The method of claim 21 wherein the organofunctional group of the coupling agent is selected from the group consisting of alkane, alkene, alcohol, epoxy, methoxy, ethoxy, acetoxy, vinyl, mono-amine, di-amine, tri-amine, and combinations thereof.

25. The method of claim 15 further comprises contacting the functionalized silicon carbide with a polymer.

26. The method of claim 24 wherein the polymer is selected from the group consisting of fluoropolymers, phenolic resins, polyesters, polyurethanes, polyolefins, acrylics, polyetherimides, polyamides, polyphenylene ethers, aliphatic polyketones, polyetherether ketones, polysulfones, aromatic polyesters, novolac resins, silicone resins, epoxy resins, polyphenylenesulfides, and combinations thereof.

27. The method of claim 24 wherein the functionalized silicon carbide at least partially crosslinks the polymer.
